(19) United States
(12) Patent Application Publication
(10) Pub. No.: US 2006/0201153 A1
(43) Pub. Date: Sep. 14, 2006

(54) Rankine cycle system

(75) Inventors: Tadashi Kurotani, Wako-shi (JP); Akihisa Sato, Wako-shi (JP); Kazuya Takahashi, Wako-shi (JP); Yuuichi Ito, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/370,849

(22) Filed: Mar. 9, 2006

(30) Foreign Application Priority Data
Mar. 9, 2005 (JP) 2005-65776

(51) Int. Cl. F02G 3/00

(52) U.S. Cl. 60/616

(57) ABSTRACT

A Rankine cycle system includes an evaporator for heating water with thermal energy of exhaust gas of an engine so as to generate steam, an expander for converting the thermal energy of the steam generated by the evaporator into mechanical energy and a temperature controller for making the temperature of the steam supplied from the evaporator to the expander coincide with a target temperature. The temperature controller includes a water supply amount controller for manipulating the amount of water supplied to the evaporator and a water injection quantity controller for supplying water to the exhaust gas upstream of the evaporator during an expansion stroke or an exhaust stroke of the engine, when the thermal energy of exhaust gas changes suddenly accompanying a change in the load of the engine and the temperature of the steam cannot be controlled at the target temperature by supply of water to the evaporator.

### CROSS-REFERENCE TO RELATED APPLICATIONS

The present application claims priority under 35 USC 119 to Japanese Patent Application No. 2005-65776 filed on Mar. 9, 2005 the entire contents of which are hereby incorporated by reference.

### BACKGROUND OF THE INVENTION

1. Field of the Invention

The present invention relates to a Rankine cycle system that includes an evaporator for heating a liquid-phase working medium with thermal energy of exhaust gas of an engine so as to generate a gas-phase working medium, an expander for converting the thermal energy of the gas-phase working medium generated by the evaporator into mechanical energy, and temperature control means for making the temperature of the gas-phase working medium supplied from the evaporator to the expander coincide with a target temperature.

2. Description of Related Art

Japanese Utility Model Registration Publication No. 2-38162 discloses an arrangement in which the temperature of steam generated by a waste heat once-through boiler using exhaust gas of an engine rotating at a constant speed as a heat source is compared with a target temperature. When a water supply signal obtained from this deviation is used in feedback control of the amount of water supplied to the waste heat once-through boiler, a feedforward signal obtained by correcting with steam pressure a throttle opening degree signal of the engine is added to the above-mentioned feedback signal, thus compensating for variation in the load of the engine to improve the precision of control.

In the above-mentioned conventional arrangement, since the steam temperature is controlled only by manipulating the amount of water supplied to the evaporator, in the case where the load of the engine suddenly changes and the thermal energy of the exhaust gas rapidly increases, there is a possibility that due to the length of a water supply pipe or the heat capacity of the evaporator a response lag might occur in the steam temperature. The steam temperature might overshoot the target temperature to deteriorate the operating efficiency of the expander.

As another method of preventing the steam temperature from overshooting the target temperature when the load of the engine suddenly changes, cylinder shut-off for the engine could be considered. However, if cylinder shut-off is carried out, the engine output itself changes, leading to a problem that when this Rankine cycle system is mounted in an automobile the driver might feel uncomfortable.

### SUMMARY OF THE INVENTION

The present invention has been accomplished under the above-mentioned circumstances, and it is an object of an embodiment of the present invention to carry out control with good responsiveness so that the temperature of steam generated in an evaporator does not overshoot a target temperature even when the operating conditions of the engine change and the thermal energy of the exhaust gas increases rapidly.

In order to achieve the above-mentioned object, according to a first feature of the invention, there is provided a Rankine cycle system including an evaporator for heating a liquid-phase working medium with thermal energy of exhaust gas of an engine so as to generate a gas-phase working medium. An expander is provided for converting the thermal energy of the gas-phase working medium generated by the evaporator into mechanical energy. A temperature control means is provided for making the temperature of the gas-phase working medium supplied from the evaporator to the expander coincide with a target temperature. The temperature control means includes liquid-phase working medium supply amount control means for manipulating the amount of liquid-phase working medium supplied to the evaporator and exhaust gas cooling means for supplying a liquid-phase cooling medium to the exhaust gas upstream of the evaporator, when the thermal energy of the exhaust gas changes suddenly accompanying a change in the load of the engine and the temperature of the gas-phase working medium cannot be controlled at the target temperature by supply of the liquid-phase working medium to the evaporator.

With the first feature, in the case where the thermal energy of the exhaust gas changes rapidly accompanying a change in the load of the engine and the temperature of the gas-phase working medium cannot be controlled at the target temperature even if the liquid-phase working medium supply amount control means of the temperature control means manipulates the amount of liquid-phase working medium supplied to the evaporator in order to make the temperature of the gas-phase working medium supplied from the evaporator to the expander of the Rankine cycle system coincide with the target temperature, the exhaust gas cooling means of the temperature control means cools the exhaust gas upstream of the evaporator by supplying the liquid-phase cooling medium. Therefore, it is possible to reliably inhibit overshooting of the temperature of the gas-phase working medium due to a rapid increase in the thermal energy of the exhaust gas.

According to a second feature of the present invention, in addition to the first feature, the exhaust gas cooling means manipulates the amount of liquid-phase cooling medium supplied based on a change in the load of the engine and a change in temperature of the exhaust gas accompanying the change in the load of the engine.

With the second feature, since the exhaust gas cooling means manipulates the amount of liquid-phase cooling medium supplied based on the change in load of the engine and the change in temperature of the exhaust gas accompanying the change in the load, it is possible to yet more reliably inhibit overshooting of the temperature of the gas-phase working medium due to a rapid increase in the thermal energy of the exhaust gas.

According to a third feature of the present invention, in addition to the second feature, the exhaust gas cooling means estimates the change in temperature of the exhaust gas based on at least one of a throttle opening degree and an accelerator opening degree.

With the third feature, since the exhaust gas cooling means estimates the change in temperature of the exhaust gas based on the throttle opening degree or the accelerator opening degree, it is possible to correctly estimate the change in temperature of the exhaust gas.

According to a fourth feature of the present invention, in addition to any one of the first to third features, the exhaust gas cooling means supplies the liquid-phase cooling medium to any position from a combustion chamber of the engine to an entrance of the evaporator.

With the fourth feature, since the exhaust gas cooling means supplies the liquid-phase cooling medium to any position from the combustion chamber of the engine to the entrance of the evaporator, it is possible to decrease the temperature of the exhaust gas effectively with the liquid-phase cooling medium.

According to a fifth feature of the present invention, in addition to any one of the first to fourth features, the exhaust gas cooling means supplies the liquid-phase cooling medium during an expansion stroke or an exhaust stroke of the engine.

With the fifth feature, since the exhaust gas cooling means supplies the liquid-phase cooling medium in the expansion stroke or the exhaust stroke of the engine, it is possible to decrease the temperature of the exhaust gas effectively with the liquid-phase cooling medium.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing the overall arrangement of a Rankine cycle system;

FIG. 2 is a control block diagram of temperature control means;

FIG. 3 is a graph showing the relationship between optimum steam temperature and maximum efficiency of an evaporator and an expander;

FIG. 4 is a flowchart of target exhaust gas temperature calculation processing;

FIGS. 5A to 5D are time charts showing changes in throttle opening degree, exhaust gas temperature, water injection quantity, and steam temperature;

FIGS. 6A and 6B are time charts showing changes in throttle opening degree, exhaust gas temperature, steam temperature, and water supply amount;

FIG. 7A is a graph showing the relationship between water injection start timing and exhaust gas temperature;

FIG. 7B is a graph showing the relationship between water injection quantity and exhaust gas temperature;

FIG. 8 is a graph showing the relationship between water injection start timing and engine output; and

FIG. 9 is a graph showing the relationship between crank angle and change in exhaust gas temperature.

### DESCRIPTION OF PREFERRED EMBODIMENT

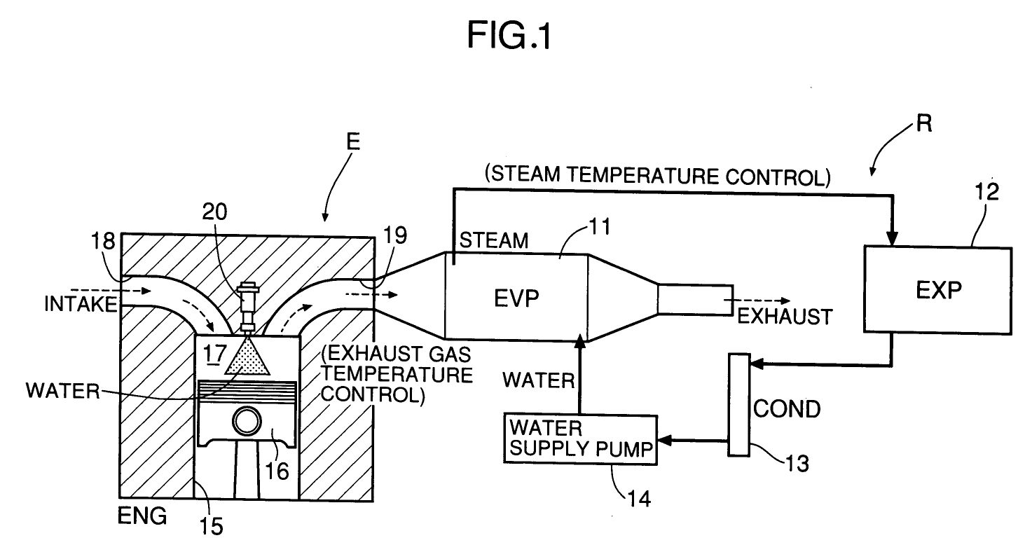

FIG. 1 shows the overall arrangement of a Rankine cycle system R to which the present invention is applied. The Rankine cycle system R recovers thermal energy of exhaust gas of an engine E, and converts it into mechanical energy. The Rankine cycle system R includes an evaporator 11, an expander 12, a condenser 13, and a water supply pump 14. The evaporator 11 heats water with the exhaust gas discharged by the engine E so as to generate high temperature, high pressure steam. The expander 12 is operated by the high temperature, high pressure steam generated by the evaporator 11 so as to generate mechanical energy. The condenser 13 cools the decreased-temperature decreased-pressure steam that has completed work in the expander 12, and turns it back into water. The water supply pump 14 pressurizes the water discharged from the condenser 13 and supplies it to the evaporator 11 again. Furthermore, the engine E includes a combustion chamber 17 defined by a cylinder 15 and a piston 16, the evaporator 11 is connected, among an intake port 18 and an exhaust port 19 communicating with the combustion chamber 17, to the exhaust port 19. The combustion chamber 17 is provided with a water injection valve 20 for injecting cooling water.

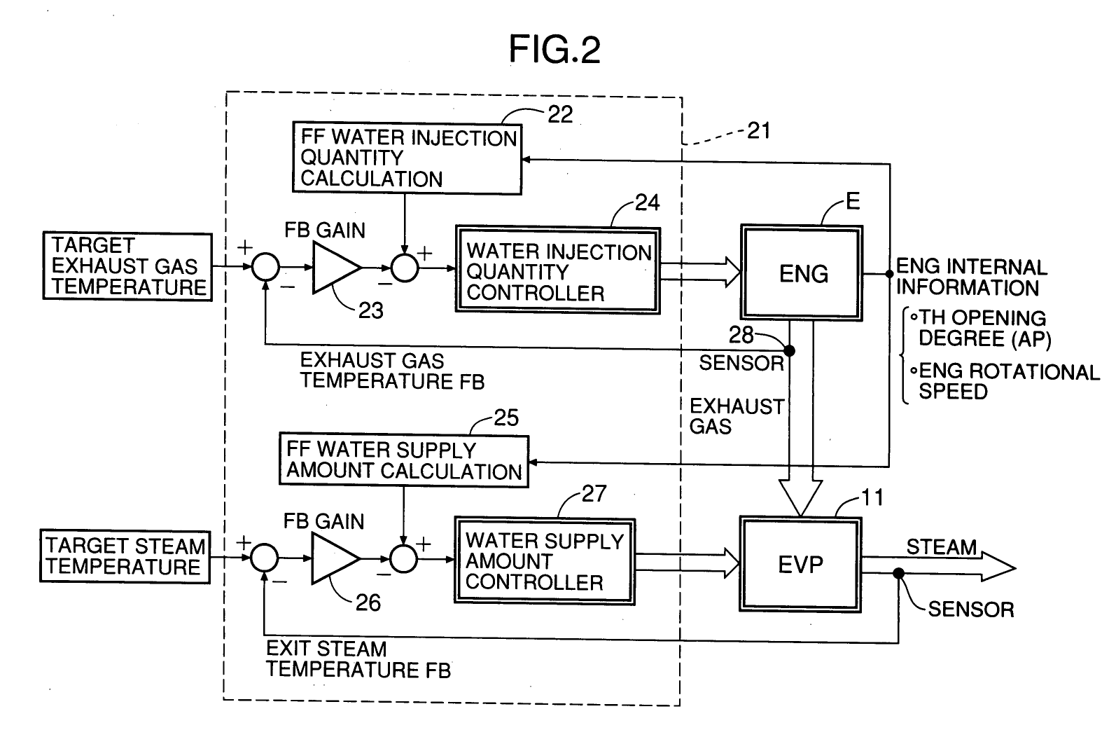

FIG. 2 shows the arrangement of temperature control means 21 for controlling the temperature of steam supplied from the evaporator 11 to the expander 12. The temperature control means 21 includes feedforward water injection quantity calculation means 22, feedback water injection quantity calculation means 23, water injection quantity controller 24, feedforward water supply amount calculation means 25, feedback water supply amount calculation means 26, and a water supply amount controller 27.

The feedforward water injection quantity calculation means 22 calculates a water injection quantity based on internal information of the engine E such as a throttle opening degree (an accelerator opening degree) or an engine rotational speed. The water injection quantity controller 24 controls the temperature of exhaust gas of the engine E by manipulating, based on the feedforward water injection quantity, the quantity of water injected from the water injection valve 20 into the combustion chamber 17. In this process, the feedback water injection quantity calculation means 23 calculates a feedback water injection quantity by multiplying a deviation from a target exhaust gas temperature of an exhaust gas temperature detected by an exhaust gas temperature sensor 28 provided on the exhaust port 19 of the engine E by a predetermined gain; and by inputting into the water injection quantity controller 24 a value obtained by subtracting this feedback water injection quantity from the feedforward water injection quantity. Therefore, responsiveness is improved due to the feedforward control, and convergence is improved due to the feedback control. A method of setting the target exhaust gas temperature is explained in detail later.

On the other hand, the feedforward water supply amount calculation means 25 calculates a water supply amount based on the internal information of the engine E such as the throttle opening degree (the accelerator opening degree) or the engine rotational speed. The water supply amount controller 27 controls the temperature of steam supplied to the expander 12 by manipulating, based on the feedforward water supply amount, the amount of water supplied from the water supply pump 14 to the evaporator 11. In this process, the feedback water supply amount calculation means 26 calculates a feedback water supply amount by multiplying a deviation from a target steam temperature of a steam temperature detected by a steam temperature sensor 29 provided on the exit of the evaporator 11 by a predetermined gain; and by inputting into the water supply amount controller 27 a value obtained by subtracting this feedback water supply amount from the feedforward water supply amount. Therefore, responsiveness is improved due to the feedforward control, and convergence is improved due to the feedback control.

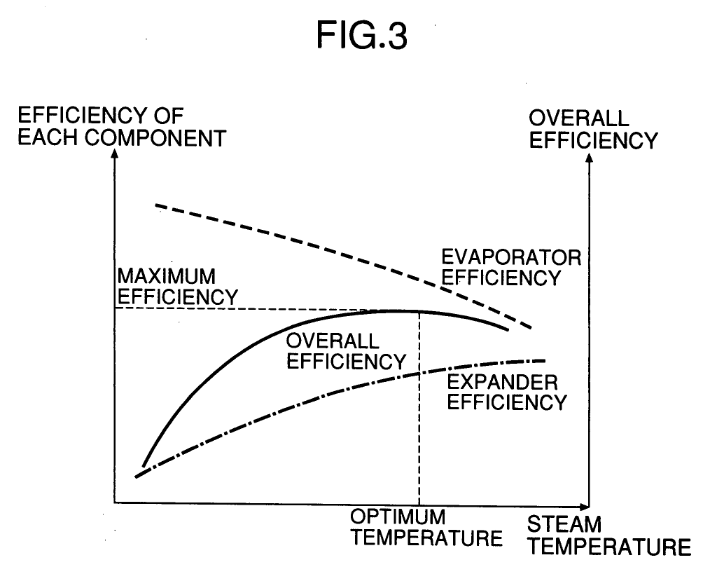

The target steam temperature is determined as follows, as shown in FIG. 3, the efficiency of the evaporator 11 and the efficiency of the expander 12 of the Rankine cycle system change according to the steam temperature, when the steam temperature increases, the efficiency of the evaporator decreases and the efficiency of the expander increases, whereas when the steam temperature decreases, the efficiency of the evaporator increases and the efficiency of the expander decreases. Therefore, there is an optimum steam temperature (a target temperature) at which the overall efficiency of the two becomes a maximum.

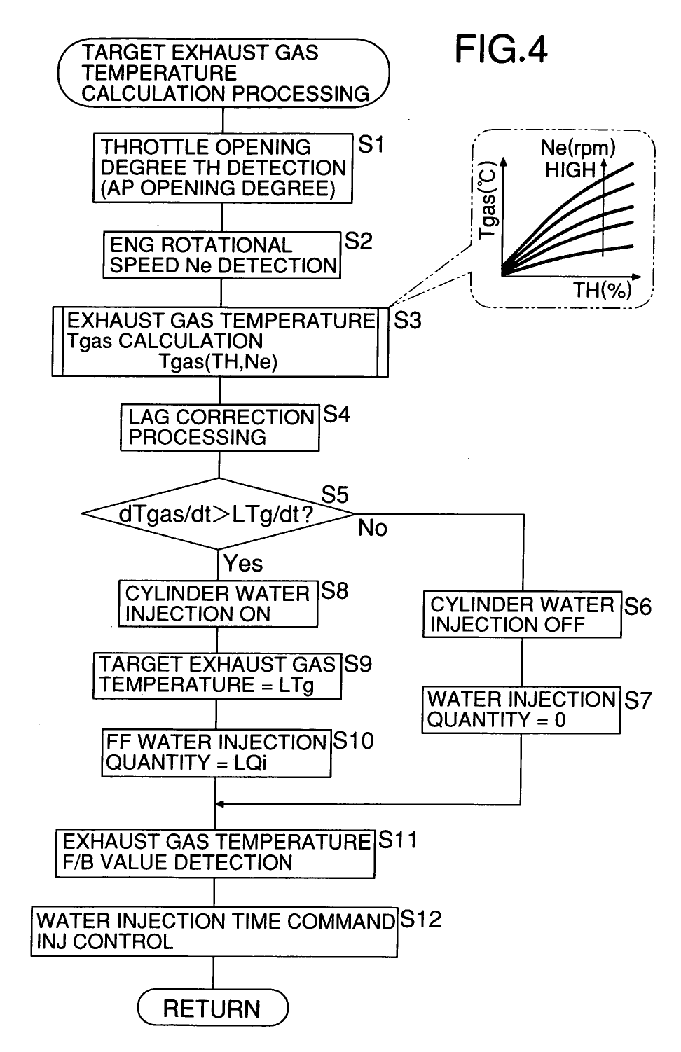

The operation of the above is now described in further detail by reference to the flowchart of FIG. 4.

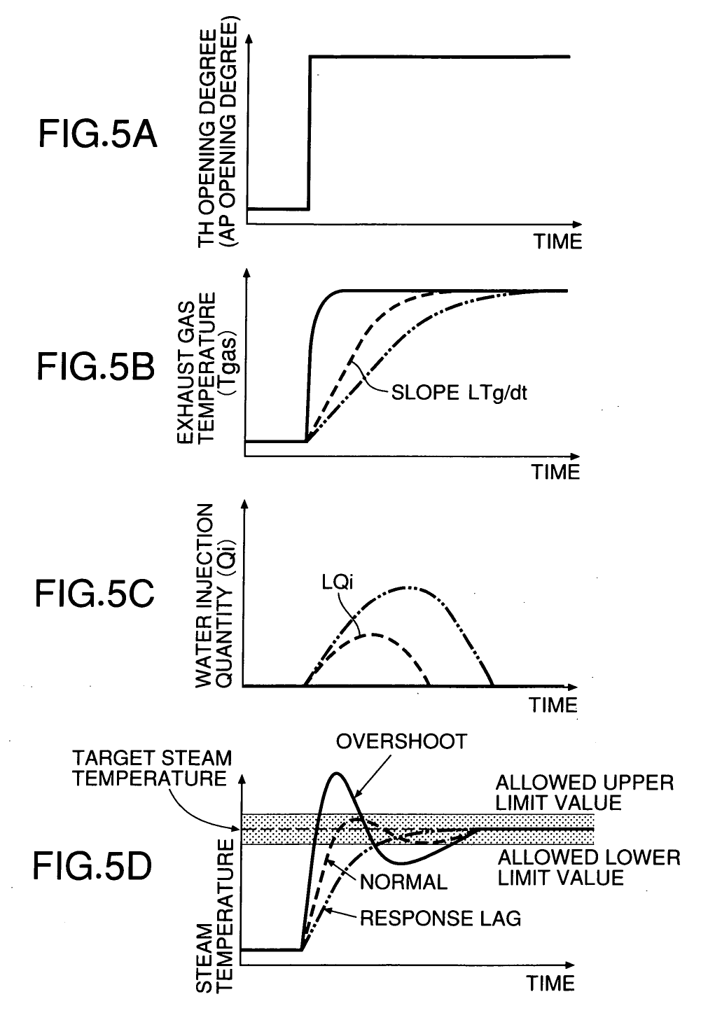

First, in step S1 a throttle opening degree TH (or an accelerator opening degree AP) is detected, in step S2 an engine rotational speed Ne is detected, and in step S3 an exhaust gas temperature Tgas is determined by map lookup using the throttle opening degree TH and the engine rotational speed Ne. In the subsequent step S4, lag correction processing is carried out in order to correct a calculation lag for the exhaust gas temperature Tgas, and if in step S5 the rate of change dTgas/dt of the exhaust gas temperature Tgas with time does not exceed a threshold value LTg/dt, that is, the rate of increase of the exhaust gas temperature Tgas is small as shown by the dotted-dashed line in FIG. 5B, then in step S6 water injection by the water injection valve 20 into the interior of the combustion chamber 17 is not carried out, and in step S7 the water injection quantity is set at 0. As shown in FIGS. 5A and 5B, the threshold value LTg/dt corresponds to the rate of increase (the slope of characteristics shown by the dashed line) of the exhaust gas temperature Tgas when the throttle opening degree TH is increased stepwise.

On the other hand, if in step S5 the rate of change dTgas/dt of the exhaust gas temperature Tgas with time exceeds the threshold value LTg/dt, that is, the rate of increase of the exhaust gas temperature Tgas is large as shown by the solid line in FIG. 5B, then in step S8 water injection by the water injection valve 20 into the interior of the combustion chamber 17 is carried out, in step S9 the target exhaust temperature is set at LTg, and in step S10 the feedforward water injection quantity calculation means 22 sets a water injection quantity LQi as shown by the dashed line in FIG. 5C. In step S11 the exhaust gas temperature sensor 28 detects an exhaust gas temperature, and in step S12 the water injection quantity controller 24 opens the water injection quantity valve 20 only for a predetermined period of time, thus injecting water into the interior of the combustion chamber 17.

To further explain the time chart of FIG. 5, as shown by the solid lines in FIGS. 5A to 5D, when the throttle opening degree TH (the accelerator opening degree AP) is increased stepwise, if the water injection quantity Qi is set at 0, since the exhaust gas temperature does not decrease but increases stepwise, there is a problem that the steam temperature exceeds the target steam temperature and overshoots an allowed upper limit value. In contrast, as shown by the dotted-dashed lines in FIGS. 5B to D, if the water injection quantity Qi is set at an excess value, since the exhaust gas temperature decreases more than necessary and the rise is delayed, there is a problem that it takes more time for the steam temperature to attain the target steam temperature and the responsiveness is degraded.

In contrast, in the present embodiment, as shown by the dashed lines in FIGS. 5B to D, the water injection quantity Qi is set at an appropriate quantity LQi, the exhaust gas temperature rises with an appropriate slope LTg/dt, and the steam temperature converges on the target steam temperature in the shortest time, thereby enhancing the responsiveness.

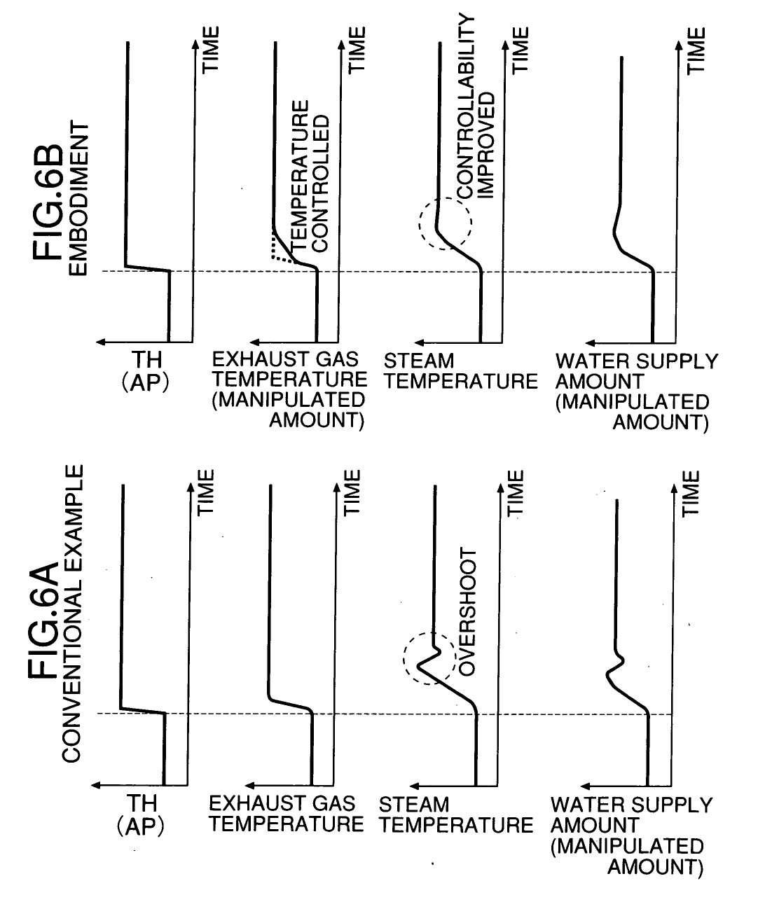

FIG. 6A and 6B are time charts for explaining the effects of the present invention; as in a conventional example shown in FIG. 6A, if the exhaust gas temperature increases because no water is injected into the combustion chamber 17, even by controlling the amount of water supplied to the evaporator 11, there is a problem that the temperature of steam from the evaporator 11 overshoots the target temperature. In contrast, as in the embodiment shown in FIG. 6B, by injecting water into the combustion chamber 17 so as to suppress an increase in the exhaust gas temperature, in cooperation with control of the amount of water supplied to the evaporator 11, it is possible to converge the temperature of steam from the evaporator 11 on the target temperature with good responsiveness.

The influence of the timing of water injection and the quantity injected into the combustion chamber 17 on the exhaust gas temperature are now investigated.

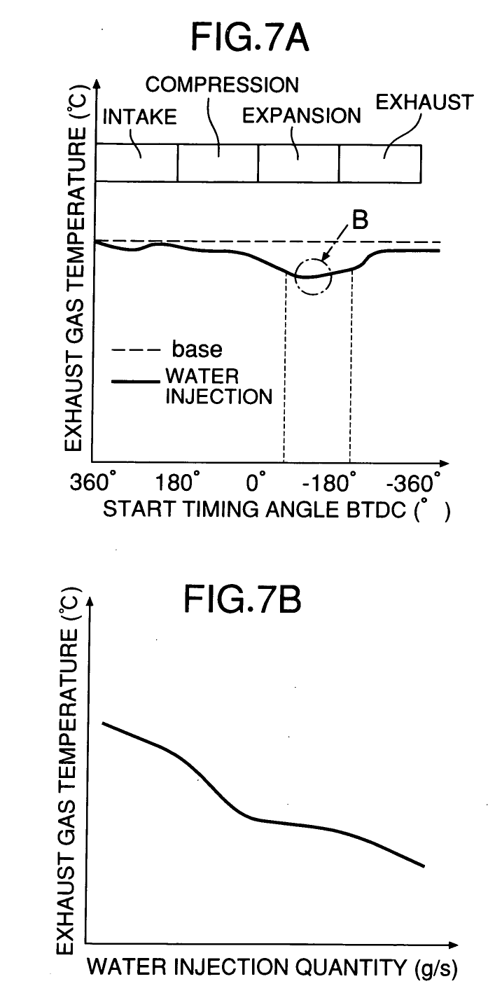

As shown in FIG. 7A, when changing the timing of starting water injection between intake stroke, compression stroke, expansion stroke, and exhaust stroke, by setting the timing in the range from −90° to −200° (position B in particular) as a crank angle before top dead center, where the TDC at which the expansion stroke starts is defined as 0°, the exhaust gas temperature decreases most effectively.

As shown in FIG. 7B, when water injection is started at position B in FIG. 7A, it can be seen that the exhaust gas temperature decreases in response to an increase in the water injection quantity. When the difference in pressure between input and output of the water injection valve 20 is constant, since the water injection quantity is determined by the valve opening time of the water injection valve 20, it is necessary to determine the valve opening time from a required water injection quantity and the engine rotational speed.

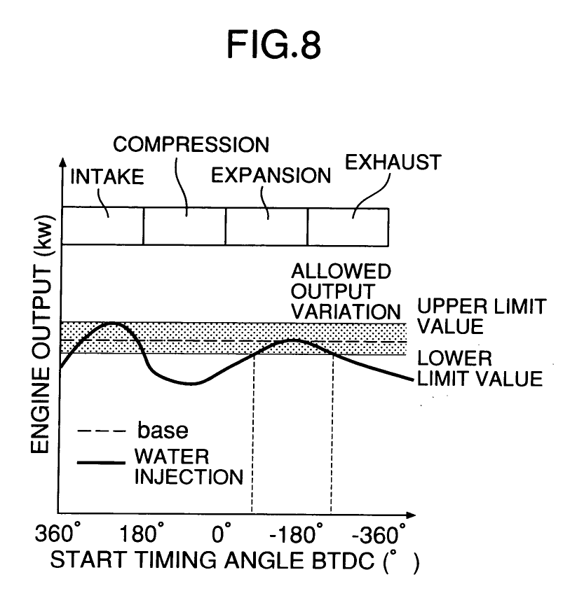

FIG. 8 shows the relationship between water injection start timing and engine output when the water injection quantity is set so that the steam temperature does not overshoot the target temperature even when the throttle opening degree is increased to 100%. When the water injection start timing is in a range from the expansion stroke to the exhaust stroke and when it is in a range of the intake stroke, variation in the engine output is contained between upper and lower limit values. Taking into consideration the exhaust gas temperature being decreased effectively as explained by reference to FIG. 7A when the water injection start timing is set in the range from the expansion stroke to the exhaust stroke (the crank angle being in the range from −90° to −200°), it can be seen that at a crank angle of −90° to −200° a decrease in engine output can be suppressed while decreasing the exhaust gas temperature.

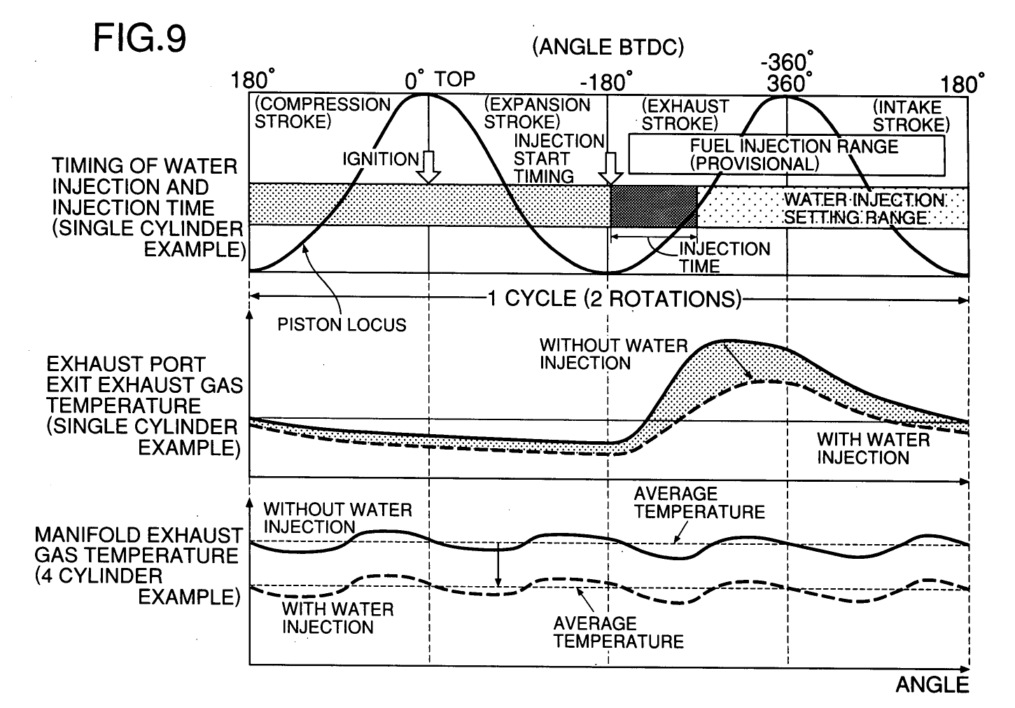

FIG. 9 shows changes in exhaust gas temperature accompanying changes in setting of the water injection start timing and the water injection time. In this case, water injection is started in the exhaust stroke (the crank angle being −200°), and it can be seen that when water injection is not carried out, the exhaust gas temperature immediately after an exhaust port of a single cylinder engine increases when an exhaust valve starts opening and decreases when the exhaust valve closes, whereas when water injection is carried out, the exhaust gas temperature decreases. In this process, it is possible to regulate a decrease in the exhaust gas temperature by regulating the water injection quantity. Furthermore, since the exhaust gas temperature in an exhaust manifold of a four-cylinder engine represents the temperature of combined exhaust gases from all the cylinders, the cycle of variation is a quarter of that of the single cylinder engine. For control of the exhaust gas temperature in the present invention, the exhaust gas temperature of this mixture is used.

Although one embodiment of the present invention has been described above, the present invention can be modified in a variety of ways as long as the modifications do not depart from the spirit and scope of the present invention.

For example, in the embodiment water is injected into the combustion chamber 17 of the engine E, but water may be injected at any position from the upstream end of the exhaust port 19 to the upstream end of the evaporator 11.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A Rankine cycle system comprising:
an evaporator for heating a liquid-phase working medium with thermal energy of exhaust gas of an engine so as to generate a gas-phase working medium;
an expander for converting the thermal energy of the gas-phase working medium generated by the evaporator into mechanical energy; and
temperature control means for making the temperature of the gas-phase working medium supplied from the evaporator to the expander coincide with a target temperature, the temperature control means comprising:
liquid-phase working medium supply amount control means for manipulating the amount of liquid-phase working medium supplied to the evaporator; and
exhaust gas cooling means for supplying a liquid-phase cooling medium to the exhaust gas upstream of the evaporator, when the thermal energy of the exhaust gas changes suddenly accompanying a change in the load of the engine and the temperature of the gas-phase working medium cannot be controlled at the target temperature by supply of the liquid-phase working medium to the evaporator.

2. The Rankine cycle system according to claim 1, wherein the exhaust gas cooling means manipulates the amount of liquid-phase cooling medium supplied based on a change in the load of the engine and a change in temperature of the exhaust gas accompanying the change in the load of the engine.

3. The Rankine cycle system according to claim 2, wherein the exhaust gas cooling means estimates the change in temperature of the exhaust gas based on at least one of a throttle opening degree and an accelerator opening degree.

4. The Rankine cycle system according to claim 1, wherein the exhaust gas cooling means supplies the liquid-phase cooling medium to any position from a combustion chamber of the engine to an entrance of the evaporator.

5. The Rankine cycle system according to claim 2, wherein the exhaust gas cooling means supplies the liquid-phase cooling medium to any position from a combustion chamber of the engine to an entrance of the evaporator.

6. The Rankine cycle system according to claim 3, wherein the exhaust gas cooling means supplies the liquid-phase cooling medium to any position from a combustion chamber of the engine to an entrance of the evaporator.

7. The Rankine cycle system according to claim 1, wherein the exhaust gas cooling means supplies the liquid-phase cooling medium during an expansion stroke or an exhaust stroke of the engine.

8. The Rankine cycle system according to claim 2, wherein the exhaust gas cooling means supplies the liquid-phase cooling medium during an expansion stroke or an exhaust stroke of the engine.

9. The Rankine cycle system according to claim 3, wherein the exhaust gas cooling means supplies the liquid-phase cooling medium during an expansion stroke or an exhaust stroke of the engine.

10. The Rankine cycle system according to claim 4, wherein the exhaust gas cooling means supplies the liquid-phase cooling medium during an expansion stroke or an exhaust stroke of the engine.

11. A Rankine cycle system comprising:
an evaporator for heating a liquid-phase working medium with thermal energy of exhaust gas of an engine for generating a gas-phase working medium;
an expander for converting the thermal energy of the gas-phase working medium generated by the evaporator into mechanical energy; and
temperature controller wherein the temperature of the gas-phase working medium supplied from the evaporator to the expander coincides with a target temperature, the temperature controller comprising:
liquid-phase working medium supply amount controller for manipulating the amount of liquid-phase working medium supplied to the evaporator; and
exhaust gas cooler for supplying a liquid-phase cooling medium to the exhaust gas upstream of the evaporator, when the thermal energy of the exhaust gas changes suddenly accompanying a change in the load of the engine and the temperature of the gas-phase working medium cannot be controlled at the target temperature by supply of the liquid-phase working medium to the evaporator.

12. The Rankine cycle system according to claim 11, wherein the exhaust gas cooler manipulates the amount of liquid-phase cooling medium supplied based on a change in the load of the engine and a change in temperature of the exhaust gas accompanying the change in the load of the engine.

13. The Rankine cycle system according to claim 12, wherein the exhaust gas cooler estimates the change in temperature of the exhaust gas based on at least one of a throttle opening degree and an accelerator opening degree.

14. The Rankine cycle system according to claim 11, wherein the exhaust gas cooler supplies the liquid-phase cooling medium to any position from a combustion chamber of the engine to an entrance of the evaporator.

15. The Rankine cycle system according to claim 12, wherein the exhaust gas cooler supplies the liquid-phase cooling medium to any position from a combustion chamber f the engine to an entrance of the evaporator.

16. The Rankine cycle system according to claim 13, wherein the exhaust gas cooler supplies the liquid-phase cooling medium to any position from a combustion chamber of the engine to an entrance of the evaporator.

17. The Rankine cycle system according to claim 11, wherein the exhaust gas cooler supplies the liquid-phase cooling medium during an expansion stroke or an exhaust stroke of the engine.

18. The Rankine cycle system according to claim 12, wherein the exhaust gas cooler supplies the liquid-phase cooling medium during an expansion stroke or an exhaust stroke of the engine.

19. The Rankine cycle system according to claim 13, wherein the exhaust gas cooler supplies the liquid-phase cooling medium during an expansion stroke or an exhaust stroke of the engine.

20. The Rankine cycle system according to claim 14, wherein the exhaust gas cooler supplies the liquid-phase cooling medium during an expansion stroke or an exhaust stroke of the engine.
